(19) United States
(12) Patent Application Publication
(10) Pub. No.: US 2025/0225403 A1
(43) Pub. Date: Jul. 10, 2025

(54) FRAMEWORK FOR AUGMENTING PERFORMANCE OF LANGUAGE MODEL-BASED COPILOT

(71) Applicant: Ivanti, Inc., South Jordan, UT (US)

(72) Inventor: Mantinder Jit Singh, Vancouver (CA)

(73) Assignee: Ivanti, Inc., South Jordan, UT (US)

(21) Appl. No.: 19/010,812

(22) Filed: Jan. 6, 2025

Related U.S. Application Data
(60) Provisional application No. 63/618,513, filed on Jan. 8, 2024.

(51) Int. Cl. G06N 3/09; G06N 3/0475

(52) U.S. Cl. CPC G06N 3/09; G06N 3/0475

(57) ABSTRACT

An embodiment includes a method of augmenting performance and compliance of language model-based copilots. The method includes receiving application-specific guidance providing instructions that restrict responses output by an application-specific copilot based on a large language model (LLM). The method includes communicating to the LLM the application-specific guidance and setting an initial set of model parameters for the LLM. The method includes sequentially optimizing model parameters related to multiple model output characteristics of the LLM to generate a final set of model parameters. The method includes communicating the final set of model parameters to the LLM such that the final set of model parameters is implemented in the LLM during operations implemented by the copilot. The method includes deploying the copilot in an environment such that the copilot receives an actual query and replies with an actual response based on the LLM implementing the final set of model parameters.

### CROSS REFERENCE TO RELATED APPLICATION

This application claims priority to and benefit of U.S. Provisional Application No. 63/618,513 filed Jan. 8, 2024, which is incorporated herein by reference in its entirety.

### FIELD

The embodiments described in this disclosure are related to frameworks implemented to augment the performance of language model-based copilots.

### BACKGROUND

Copilots are implemented in computing systems to provide a question-and-answer based support and content generation. For instance, a user may audibly input a question or prompt to the copilot. The copilot replies with an answer to the question or generates content based on the input.

Copilots often use large language models (LLM) to derive the answer. For instance, the copilot serves as an input-output intermediary with the LLM. The LLM generates the reply or content, which is conveyed to the user via the copilot. Some systems such as software-as-a-service (SaaS) management systems implement a copilot to support users. In these and other systems, a user may use the copilot to troubleshoot a technical issue, identify instructions for a particular function, generate a subset of data, or seek other support.

Several challenges exist in conventional copilots, especially those copilots that are related to a specific application or vendor. The challenges may include alignment issues, hallucinations and inaccuracies, response inconsistency, and compliance issues. Alignment issues relate to the copilot's failure to meet standards and prescribed rules established for the copilot. Conventional copilots often deviate from the prescribed rules, which may result in responses being unsuitable or inappropriate. Hallucinations are inaccurate answers, which may result from fabrication of information when an actual answer cannot be found. Hallucinations may result in a user being misguided with false information. Inconsistency relates to different answers resulting from similar or substantially similar input. Compliance relates to legal and privacy concerns that underly use of large-scale data aggregation and utilization.

Accordingly, there is a need in the field of LLM-based copilot systems to improve the challenges such as alignment, inaccuracy, inconsistency, and compliance. Embodiments of the present disclosure provide a framework implemented to improve these and other aspects of an application-specific copilot that is deployed in a user environment.

The subject matter claimed herein is not limited to embodiments that solve any disadvantages or that operate only in environments such as those described. Rather, this background is only provided to illustrate one example technology area where some embodiments described herein may be practiced.

### SUMMARY

According to an aspect of the invention, an embodiment includes method of augmenting performance and compliance of language model-based copilots. The method may include receiving application-specific guidance that provides one or more instructions that restrict responses output by an application-specific copilot that is based on a large language model (LLM). The method may include communicating to the LLM the application-specific guidance. The method may include setting an initial set of model parameters for the LLM. The method may include sequentially optimizing model parameters related to one or more of multiple model output characteristics of the LLM to generate a final set of model parameters. The optimizing the model parameters includes, after the initial set of model parameters are implemented at the LLM, generating and submitting to the copilot a first query configured to test a first model output characteristic of the multiple model output characteristics. The first query represents a question input to the copilot. The multiple model output characteristics include alignment of output of the LLM, accuracy of output of the LLM, and consistency of output of the LLM. The optimizing the model parameters further includes evaluating a first copilot response based on the application-specific guidance. Evaluation of the first copilot response includes comparing the first copilot response to one or more ground truth responses and scoring the first copilot response using metrics including similarity, relevance, and coherence. The method may include communicating the final set of model parameters to the LLM such that the final set of model parameters is implemented in the LLM during operations implemented by the copilot. The method may include deploying the copilot in an environment such that the copilot is configured to receive an actual query and to reply with an actual response based on the LLM implementing the final set of model parameters.

An additional aspect of an embodiment includes a non-transitory computer-readable medium having encoded therein programming code executable by one or more processors to perform or control performance at least a portion of the method described above.

Yet another aspect of an embodiment includes a computer device. The computer device may include one or more processors and a non-transitory computer-readable medium. The non-transitory computer-readable medium has encoded therein programming code executable by the one or more processors to perform or control performance of one or more of the operations of the methods described above.

The object and advantages of the embodiments will be realized and achieved at least by the elements, features, and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 depicts a block diagram of an example operating environment in which some embodiments of the present disclosure may be implemented;

FIG. 2 is a block diagram of an example parameter optimization process that may be implemented in the operating environment of FIG. 1;

FIG. 3 illustrates an example computer system configured for copilot augmentation and model parameter optimization for a copilot that uses a large language model;

FIGS. 4A and 4B are a flow chart of an example method of augmenting performance and compliance of language model-based copilots;

FIGS. 5A and 5B are a flow chart of an example method of optimizing model parameters related to one or more of multiple model output characteristics of an LLM to generate a final set of model parameters with which a copilot is deployed; and

FIG. 6 is a flow chart of another example method of optimizing model parameters related to one or more of multiple model output characteristics of an LLM to generate a final set of model parameters with which a copilot is deployed,

all according to at least one embodiment described in the present disclosure.

### DESCRIPTION OF SOME EXAMPLE EMBODIMENTS

Embodiments of the present disclosure are related to frameworks implemented to augment the performance of language model-based copilots. The framework includes one or more modules directed to optimize model parameters implemented in a large language model (LLM)—based copilots. In some embodiments, each of the modules sequentially optimizes one or more parameters related to a model characteristic based on a guidelines and application-specific content provided to the LLM.

For instance, the framework may include an alignment module, an accuracy module, and a consistency module. The framework may provide guidelines configured to restrict and direct output of the copilot as well as submit an initial set of parameters to the LLM. Each of the modules communicates one or more queries to the copilot. The responses are evaluated based on the guidelines. Based on the evaluation, one or more of the parameters may be adjusted, the guidelines may be adjusted, or the application-specific content may be adjusted. After the adjustment(s), the LLM may be updated with adjustments (e.g., adjusted parameters, adjusted guidelines, adjusted application-specific content, or combinations thereof). An additional query is submitted, a corresponding response is evaluated, and further adjustments are made based on the evaluation.

The framework may sequentially optimize parameters for the modules. For instance, in the prior example, parameters related to alignment may be optimized, followed by parameters related to accuracy, and then parameters related to consistency. This optimization process may be implemented to generate a final set of model parameters that are implemented in the LLM. The copilot may then be deployed in a user environment.

These and other embodiments are described with reference to the appended Figures in which like item number indicates like function and structure unless described otherwise. The configurations of the present systems and methods, as generally described and illustrated in the Figures herein, may be arranged and designed in different configurations. Thus, the following detailed description of the Figures, is not intended to limit the scope of the systems and methods, as claimed, but is merely representative of example configurations of the systems and methods.

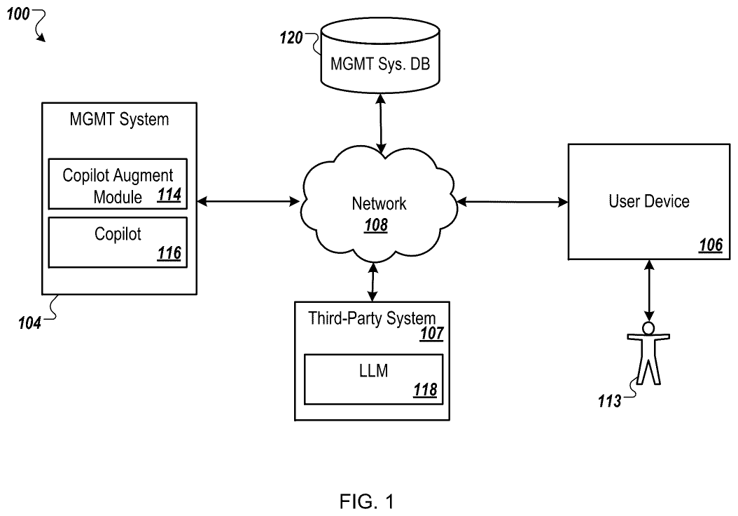

FIG. 1 is a block diagram of an example operating environment 100 in which some embodiments of the present invention can be implemented. The operating environment 100 may include a computing network in which a management system 104 implements management services relative to a user device 106. The management services may include unified endpoint management, service management (e.g., help desk and technical ticketing), patch management, application management, asset management, vulnerability detection, other management services, or combinations thereof.

To support the management services, the management system 104 may implement a copilot 116. The copilot 116 may be application-specific. As used in the present disclosure, “application-specific” indicates that the copilot 116 or another component is implemented relative to one or a limited number (e.g., two or three) management services or one or a limited number (e.g., two or three) applications. For instance, the copilot 116 may be implemented to support service management. Accordingly, a user 113 may be able to implement the copilot 116 to obtain support related to service management operations.

The management system 104 may include a copilot augment module 114. The copilot augment module 114 includes a framework that is configured to improve the performance of the copilot 116. For instance, the copilot augment module 114 may be configured to optimize parameters of an LLM 118 used by the copilot 116. By optimizing parameters of the LLM 118, the copilot augment module 114 improves model output characteristics such as accuracy, alignment, and consistency of the copilot 116.

The operating environment 100 includes a user device 106 associated with a user 113, a management system database 120 (in the Figures “MGMT Sys. DB”), a third-party system 107, and the management system 104 that are configured to communicate data and information related to augmenting the copilot 116 via a network 108. Each component of the operating environment 100 is introduced in the following paragraphs.

The network 108 may include one or more wide area networks (WANs) and/or local area networks (LANs) that enable the components (e.g., 104, 106, 120, and 107) to communicate with each other. In some embodiments, the network 108 may include the Internet in which communicative connectivity between the components of the operating environment 100 is formed by logical and physical connections between multiple WANs and/or LANs. Additionally or alternatively, the network 108 may include one or more cellular radio frequency (RF) networks, one or more wired networks, one or more wireless networks (e.g., 802.xx networks), Bluetooth access points, wireless access points, Internet Protocol (IP)-based networks, or any other wired and/or wireless networks. The network 108 may also include servers that enable one type of network to interface with another type of network.

The copilot 116 is based on the LLM 118. The LLM 118 is a large scale, language model implemented to understand and generate general language. The LLM 118 may be based on artificial neural networks and may be trained on large data sets (e.g., substantial portions of the internet). Some examples of the LLM 118 may include GPT™ by OpenAI™, PaLM™ by Google™, LLaMA™ by Meta™, Ernie 3.0 Titan™, BLOOM™, and Claude 2™ by Anthropic™.

The LLM 118 may be developed and hosted by a third-party system 107. From the immediately preceding example, the third-party system 107 may include Google, OpenAI, Meta, etc. The third-party system 107 may include one or more hardware-based devices configured to host the LLM 118 and to enable access to the LLM 118 by the copilot 116 via a network 108. For instance, the copilot 116 may receive input from the user 113 or a user device 106. The copilot 116 may communicate the input to the LLM 118 to generate a response or other content based on the input. The response or the other content may be communicated to the copilot 116, such that it may be relayed to the user 113 or the user device 106. Additionally, the LLM 118 may receive in-context learning parameters from a copilot augment module 114 and/or application-specific content from the management system 104 and the management system database 120. Some additional details of the in-context learning parameters and the application-specific content are provided elsewhere in the present disclosure.

The user device 106 may include a hardware-based computing device that is configured to communicate with the other environment components via the network 108. The user device 106 is configured to communicate with and receive instruction from the management system 104. For example, the user device 106 may communicate with the management system 104 over an intranet or an extranet via the transmission control protocol/internet protocol (TCP/IP) or another suitable protocol. Examples of the user device 106 include desktop computers, laptop computers, tablet computers, servers, cellular phones, smartphones, routers, gaming systems, etc.

The user device 106 may be associated with the user 113. The user 113 may be an individual, a set of individuals, or a system that interfaces with the user device 106. In some embodiments, the user 113 may provide input to the copilot 116 via the user device 106. For instance, the user device 106 may include a user interface such as a speaker, a touchscreen, and/or a keyboard. The user 113 may provide input via the speaker. The audio input may be communicated to the copilot 116. Additionally or alternatively, the user 113 may use the touchscreen or keyboard to type or otherwise provide input to the copilot 116.

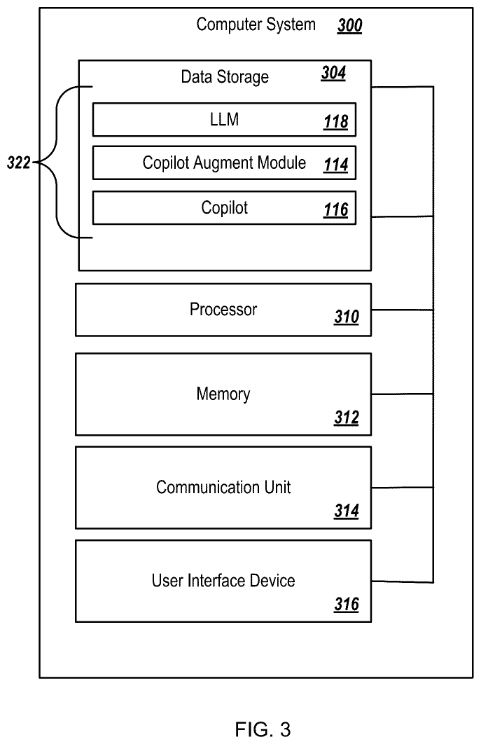

The management system database 120 may include a hardware-based storage device. The management system database 120 may include a non-transitory computer-readable medium (e.g., the memory 312 of FIG. 3). The management system database 120 may enable access to application-specific content (hereinafter, “content”) by the LLM 118. The application-specific content may include technical manuals, blogs, support documents, marketing materials and the like that are related to an application that is supported by the copilot 116. The LLM 118 may be configured to use the content to generate responses to queries and input received by the copilot 116. In some embodiments, the copilot augment module 114 may provide the content to the LLM 118 and may ensure that the LLM 118 is properly retrieving the content when generating the responses. In the depicted embodiment, the management system database 120 is depicted as separate from the management system 104. In some embodiments, the management system database 120 may be at least partially included in the management system 104 and/or at least partially in the user device 106.

The management system 104 may include a hardware-based computing system. The management system 104 may be communicatively coupled to the third-party system 107, the management system database 120, and the user device 106 via the network 108. In some embodiments, the management system 104 is included as a portion of one or more cloud-based servers or a distributed server functionality implemented across one or more cores in a remote cloud computing network.

The management system 104 may include the copilot 116 and the copilot augment module 114. As introduced above, the copilot 116 may be augmented by the copilot augment module 114 and deployed in a user environment that includes the user device 106. After the copilot 116 is deployed, the user 113 may provide actual input and receive actual responses from the copilot 116. The responses may provide information and support related to an application or a management service provided by the management system 104.

In some embodiments, the copilot 116 is hosted on the management system 104. In some embodiments, the copilot 116 is at least partially hosted on the user device 106. Additionally or alternatively, the copilot 116 may be deployed or at least partially deployed into a user environment that is a managed network. The managed network may include a secondary management device and the user device 106.

After the copilot 116 is deployed, the copilot 116 may be configured to receive feedback from the user 113 or the user device 106. The feedback may relate to responses output by the copilot 116. The feedback may be used by the copilot augment module 114 to further augment the copilot 116.

The copilot augment module 114 may implement a framework that is configured to augment the copilot respective to an application or a management service. Additionally, the copilot augment module 114 may be configured to improve model output characteristics such as accuracy, alignment, and consistency. For instance, the copilot augment module 114 may receive application-specific guidance (hereinafter, “guidance”). The guidance provides one or more instructions and rules that restrict responses output by the copilot 116. The guidance may include, for instance, a first guideline to not disparage a vendor such as a vendor of management services implemented by the management system 104, a second guideline to default to an “unknown” message (e.g., “an answer cannot be found”) when an answer cannot be found, a third guideline to maintain a particular tone in the response, a fourth guideline to not discuss a competitor, other guidelines, or combinations thereof.

The copilot augment module 114 may communicate the guidance to the LLM 118. The guidance may be used as a type of input to the LLM 118 to restrict or to constrain responses. The copilot augment module 114 may set an initial set of model parameters for the LLM 118. The initial set of model parameters may include the parameters that dictate the decisions and content creation operations of the LLM 118. Examples of the parameters may include temperature, maximum length, top_p, frequency penalty, presence penalty, stop sequences, other settings for the LLM 118, and combinations thereof.

The copilot augment module 114 may sequentially optimize model parameters related to one or more of multiple model output characteristics of the LLM 118 to generate a final set of model parameters. Processes of parameter optimization may be performed for each model output characteristics in some embodiments. Additionally, the parameter optimization may be performed sequentially. For instance, in some embodiments, the model characteristics may include alignment, accuracy, and consistency. In this example, the parameters related to alignment may be optimized first, followed by parameters related to the accuracy, then followed by the parameters related to the consistency.

To generate the final set of model parameters, the processes of parameter optimization may communicate the initial set of model parameters to the LLM 118 such that the initial set of model parameters dictate responses output by the LLM 118 via the copilot 116. The copilot augment module 114 may generate and submit queries to the copilot 116 that represent input from a user. The copilot augment module 114 may evaluate responses to the queries and make adjustments in circumstances in which the responses are non-compliant with the guidance. In some embodiments, the copilot augment module 114 may submit one query at a time and make adjustments following each query. In other embodiments, multiple queries may be submitted, and adjustments may be made following evaluation of multiple responses. After the responses received from the copilot 116 are compliant with the guidance, the copilot augment module 114 sets the final set of model parameters as the set of model parameters that resulted in the compliant responses.

The copilot augment module 114 may communicate the final set of model parameters to the LLM 118 such that the final set of model parameters is implemented in the LLM 118 during operations implemented by the copilot 116. The copilot augment module 114 or another system of the management system 104 may deploy the copilot 116 in an environment such that the copilot 116 is configured to receive an actual query and to reply with an actual response based on the LLM 118 implementing the final set of model parameters.

The copilot augment module 114, the copilot 116, the LLM 118, and components thereof may be implemented using hardware including a processor, a microprocessor (e.g., to perform or control performance of one or more operations), a field-programmable gate array (FPGA), or an application-specific integrated circuit (ASIC). In some other instances, copilot augment module 114, the copilot 116, the LLM 118, may be implemented using a combination of hardware and software. Implementation in software may include rapid activation and deactivation of one or more transistors or transistor elements such as may be included in hardware of a computing system (e.g., the user device 106, the management system 104, or the third-party system 107 of FIG. 1). Additionally, software defined instructions may operate on information within transistor elements. Implementation of software instructions may at least temporarily reconfigure electronic pathways and transform computing hardware.

Modifications, additions, or omissions may be made to the operating environment 100 without departing from the scope of the present disclosure. For example, the operating environment 100 may include one or more management systems 104, one or more user devices 106, one or more third-party systems 107, one or more management system databases 120, or any combination thereof. Moreover, the separation of various components and devices in the embodiments described herein is not meant to indicate that the separation occurs in all embodiments. Moreover, it may be understood with the benefit of this disclosure that the described components and servers may generally be integrated together into a single component or server or separated into multiple components or servers.

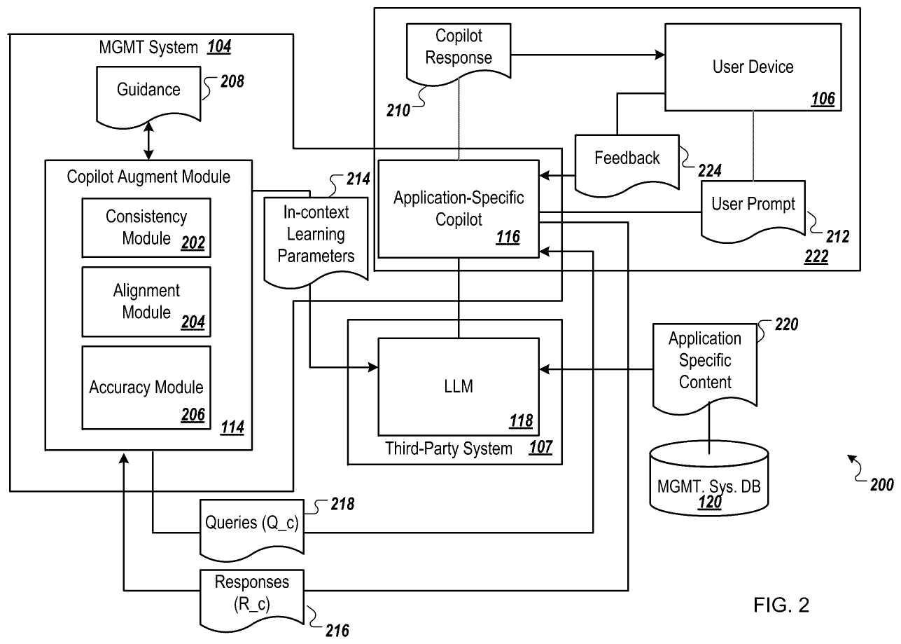

FIG. 2 is a block diagram of an example parameter optimization process 200 (process 200) that may be implemented in the operating environment 100 of FIG. 1 or another suitable operating environment. The process 200 may include or involve one or more components (e.g., 104, 106, 114, 116, 116, 118, and 120, etc.) described with reference to FIG. 1. Although not depicted in FIG. 2, one or more of the communications described with reference to FIG. 2 may be via the network 108 or another suitable communication network.

The process 200 of FIG. 2 is described in a system in which three model characteristic modules 202, 204, and 206 (hereinafter, “characteristic modules 202/204/206”) are included in the copilot augment module 114. In other embodiments, other or some additional characteristic modules 202/204/206 may be included in the copilot augment module 114.

The process 200 is described with reference to an alignment module 204, which may be the first characteristic modules 202/204/206 for which parameters are optimized. The process 200 may be repeated at each of the characteristic modules 202/204/206 until responses 216 are compliant. Following implementation of the process 200 in the first of the characteristic modules 202/204/206 (e.g., the alignment module 204), the process is repeated for the remaining characteristic modules 202/204/206.

The process 200 may begin by the copilot augment module 114 receiving the guidance 208. The guidance 208 provides one or more instructions and rules that restrict the responses 216 output by the copilot 116. The guidance 208 may include a file including the rules, which is communicated as a portion of in-context learning parameters 214 to the LLM 118. After the guidance is received at the LLM 118, the guidance 208 is used to influence or restrict how the responses 216 are generated.

The copilot augment module 114 may be configured to optimize parameters relative to each of the characteristic modules 202/204/206. To initiate the optimization, the copilot augment module 114 may communicate an initial set of model parameters to the LLM 118. The initial set of model parameters may be included as a portion of the in-context learning parameters 214. The initial set of model parameters may be determined using an ad hoc operation and/or based on model parameters that are implemented in similar copilots. The determination of the initial set of model parameters represents a cold start problem, which is addressed through remaining portions of the process 200.

The copilot augment module 114 may also connect the LLM 118 to the management system database 120. The management system database 120 may enable access to application specific content 220 (hereinafter, “content”). The content 220 may include materials that may be relied upon by the LLM 118 in generating the responses 216. For instance, the LLM 118 may be trained on a wide variety of materials that include large sections of the internet that are not related necessarily to the application that the copilot 116 supports.

In some embodiments, the copilot augment module 114 may process the content 220 to enable ingestion of the content 220 by the LLM 118. For instance, the copilot augment module 114 may break the content 220 into smaller chunks and perform an embedding process (e.g., using an embedding generator). The embedded content may be vectorized (e.g., using a Pinecone Vector DB) and communicated to an orchestrator. The copilot 116 and the LLM 118 may refine raw responses using the orchestrator to generate the responses 216.

Accordingly, the content 220 provides to the LLM 118 specific information that may be incorporated in the responses 216 and may more specifically address the queries 218. In some embodiments, the copilot augment module 114 may configure the content 220 and/or provide additional instructions that direct the LLM 118 to the content 220 as a weighted source above more general information that may be available in the training data or another external source.

With the initial set of model parameters, the content 220, and the guidance 208, the copilot 116 may be in an initial configuration from which model parameters may be optimized for each of the characteristic modules 202/204/206. The process 200 may begin with the alignment module 204. The alignment module 204 may generate a first alignment query, which is generally represented in FIG. 2 by queries 218. The alignment module 204 submits the first alignment query to the copilot 116, which is operating under the initial configuration. The first alignment query is representative of a user prompt 212 or an actual query that may be input to the copilot 116 during normal operation.

In response to the first alignment query, the copilot 116 replies with a first alignment response, which is generally represented in FIG. 2 by the responses 216. The first alignment response is generated based on the initial configuration of the copilot 116 and LLM 118.

The alignment module 204 evaluates the first alignment response based on the guidance 208. For instance, the guidance 208 may include a first guideline that restricts mention of a competitor's product. The first alignment query may input “Is vendor A better than vendor B” in which vendor B is the competitor of vendor A. The first alignment response may output a message “vendor B is better than vendor A.” Accordingly, the first alignment response is non-compliant with the first guideline.

The evaluation of the responses 216 by the characteristic modules 202/204/206 may be implemented manually or may be automated. For instance in automated systems, the responses 216 may be compared to one or more ground truth responses. The responses 216 may be scored based on the comparison using one or more metrics such as similarity, relevance, and coherence. If the score is too low, the response under evaluation is deemed non-compliant.

When the first alignment response is non-compliant, the alignment module 204 may adjust or modify one of the elements of the initial configuration. For instance, the alignment module 204 may adjust one or more of the initial set of parameters, may modify the guidance 208 (for instance re-ordering the guidelines), may modify an input prompt (e.g., one of the queries 218), may modify the configuration or the access to the content 220, or some combination thereof. The alignment module 204 may communicate modified elements to the LLM 118 as a portion of the in-context learning parameters 214. The in-context learning parameters 214, including the modified elements, generates an intermediate configuration of the copilot 116 and LLM 118.

The alignment module 204 may then generate and submit a second alignment query to the copilot 116. The alignment module 204 may evaluate a second alignment response and modify one or more of the elements of the intermediate configuration. This series of operations is continued by the alignment module 204 until the alignment module 204 receives one or more alignment responses that are compliant with the guidance 208.

In some instances, the alignment module 204 may adjust model parameters related to alignment of output by the LLM 118. For instance, the alignment module 204 may generate one or more intermediate sets of model parameters that include some of the initial set of model parameters as well as some model parameters that have been adjusted based on the evaluation of the alignment responses.

Following compliance of the alignment responses, the alignment module 204 may cease optimization operations. A final set of alignment model parameters may be implemented at the LLM 118 along with the guidance 208 or modified versions of the guidance 208, as an additional intermediate configuration. A second of the characteristic modules 202/204/206, for instance the accuracy module 206, may then perform a similar parameter optimization relative to model parameters that are related to accuracy of output by the LLM 118 and the copilot 116.

For example, the accuracy module 206 may generate and submit to the copilot 116 a first accuracy query and receive in reply a first accuracy response. The accuracy module 206 may evaluate the first accuracy response based on the guidance 208 and modify one or more elements of the intermediate configuration. The accuracy module 206 may then submit one or more additional accuracy queries, evaluate the additional accuracy responses, and modify elements when the additional accuracy responses are non-compliant. For example, the accuracy module 206 may generate one or more intermediate sets of model parameters, which may include some of the parameters of the final set of model parameters after the alignment module 204 is optimized and some other parameters that have been modified when one or more of the additional accuracy responses are non-compliant.

Following compliance of the accuracy responses, the accuracy module 206 may cease optimization operations. A final set of alignment model parameters may be implemented at the LLM 118 along with the guidance 208 or modified versions of the guidance 208, as an additional intermediate configuration. A third of the characteristic modules 202/204/206, the consistency module 202, may then perform a similar parameter optimization relative to model parameters that are related to consistency of output by the LLM 118 and the copilot 116.

Following compliance of the consistency responses, the consistency module 202 may cease optimization operations. A final set of model parameters may be communicated to the LLM 118 as a portion of the in-context learning parameters 214. The final set of model parameters after optimization of the final module of the characteristic modules 202/204/206 generates a final configuration of the copilot 116 and the LLM 118.

The copilot augment module 114 or the management system 104 may deploy the copilot 116 to a user environment 222. The copilot 116 may be deployed such that the user device 106 communicates the user prompt 212, as an actual query, and replies with an actual copilot response 210 based on the LLM 118, which is implementing the final set of model parameters. Following deployment of the copilot 116 in the user environment 222, the copilot 116 may collect feedback 224 from users (e.g., 113 of FIG. 1) of the copilot 116. The copilot augment module 114 may modify the final set of model parameters based on the collected feedback.

In some embodiments, the queries 218 may be static or dynamic. The queries 218 that are static may be implemented each time the process 200 is implemented. For instance, the alignment queries may be static in some embodiments. The queries 218 that are dynamic may change. The queries 218 may change based on previous queries 218 and/or response 216 or a particular behavior of the copilot 116. Additionally or alternatively, the queries 218 may be based on the feedback 224 from similar copilots or following deployment of the copilot 116. For instance, the feedback 224 may indicate inconsistent responses that repeat or recur. Accordingly, consistency queries may be generated to test the behavior following an adjustment in one or more model parameters.

In some embodiments, different model parameters may be adjusted for each of the characteristic modules 202/204/206. For instance, for the alignment module 204 an adjustment of the one or more parameters may include selection of different ranges in one or more or a combination of temperature, top_p, presence penalty, and frequency penalty. Similarly, for the accuracy module 206, an adjustment of the one or more parameters may include selecting different ranges in one or more or a combination of similarity threshold, chunk size, and embedding model choice. For the consistency module 202, an adjustment of the one or more parameters may include selection of different ranges in one or more or a combination of system prompt, temperature, and top_p.

FIG. 3 illustrates an example computer system 300 configured for copilot augmentation and model parameter optimization for a copilot that uses an LLM according to at least one embodiment of the present disclosure. The computer system 300 may be implemented in the operating environment 100 of FIG. 1 or another suitable operating environment. Examples of the computer system 300 may include the user device 106, the management system 104, the third-party system 107, or some combination thereof. The computer system 300 may include one or more processors 310, a memory 312, a communication unit 314, a user interface device 316, and a data storage 304 that includes the LLM 118, the copilot augment module 114, and the copilot 116 (collectively, modules 322).

The processor 310 may include any suitable special-purpose or general-purpose computer, computing entity, or processing device including various computer hardware or software modules and may be configured to execute instructions stored on any applicable computer-readable storage media. For example, the processor 310 may include a microprocessor, a microcontroller, a digital signal processor (DSP), an ASIC, an FPGA, or any other digital or analog circuitry configured to interpret and/or to execute program instructions and/or to process data. Although illustrated as a single processor in FIG. 3, the processor 310 may more generally include any number of processors configured to perform individually or collectively any number of operations described in the present disclosure. Additionally, one or more of the processors 310 may be present on one or more different electronic devices or computing systems. In some embodiments, the processor 310 may interpret and/or execute program instructions and/or process data stored in the memory 312, the data storage 304, or the memory 312 and the data storage 304. In some embodiments, the processor 310 may fetch program instructions from the data storage 304 and load the program instructions in the memory 312. After the program instructions are loaded into the memory 312, the processor 310 may execute the program instructions.

The memory 312 and the data storage 304 may include computer-readable storage media for carrying or having computer-executable instructions or data structures stored thereon. Such computer-readable storage media may include any available media that may be accessed by a general-purpose or special-purpose computer, such as the processor 310. By way of example, and not limitation, such computer-readable storage media may include tangible or non-transitory computer-readable storage media including RAM, ROM, EEPROM, CD-ROM or other optical disk storage, magnetic disk storage or other magnetic storage devices, flash memory devices (e.g., solid state memory devices), or any other storage medium which may be used to carry or store desired program code in the form of computer-executable instructions or data structures and that may be accessed by a general-purpose or special-purpose computer. Combinations of the above may also be included within the scope of computer-readable storage media. Computer-executable instructions may include, for example, instructions and data configured to cause the processor 310 to perform a certain operation or group of operations.

The communication unit 314 may include one or more pieces of hardware configured to receive and send communications. In some embodiments, the communication unit 314 may include one or more of an antenna, a wired port, and modulation/demodulation hardware, among other communication hardware devices. In particular, the communication unit 314 may be configured to receive a communication from outside the computer system 300 and to present the communication to the processor 310 or to send a communication from the processor 310 to another device or network (e.g., the network 108 of FIG. 1).

The user interface device 316 may include one or more pieces of hardware configured to receive input from and/or provide output to a user. In some embodiments, the user interface device 316 may include one or more of a speaker, a microphone, a display, a keyboard, a touch screen, or a holographic projection, among other hardware devices.

The modules 322 may include program instructions stored in the data storage 304. The processor 310 may be configured to load the modules 322 into the memory 312 and execute the modules 322. Alternatively, the processor 310 may execute the modules 322 line-by-line from the data storage 304 without loading them into the memory 312. When executing the modules 322, the processor 310 may be configured to perform one or more processes or operations described elsewhere in this disclosure.

Modifications, additions, or omissions may be made to the computer system 300 without departing from the scope of the present disclosure. For example, in some embodiments, the computer system 300 may not include the user interface device 316. In some embodiments, the different components of the computer system 300 may be physically separate and may be communicatively coupled via any suitable mechanism. For example, the data storage 304 may be part of a storage device that is separate from a device, which includes the processor 310, the memory 312, and the communication unit 314, that is communicatively coupled to the storage device. The embodiments described herein may include the use of a special-purpose or general-purpose computer including various computer hardware or software modules, as discussed in greater detail below.

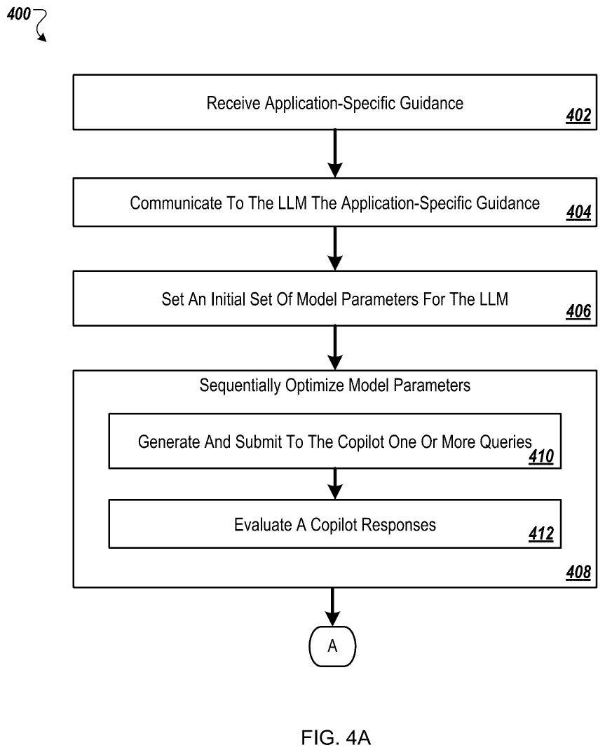

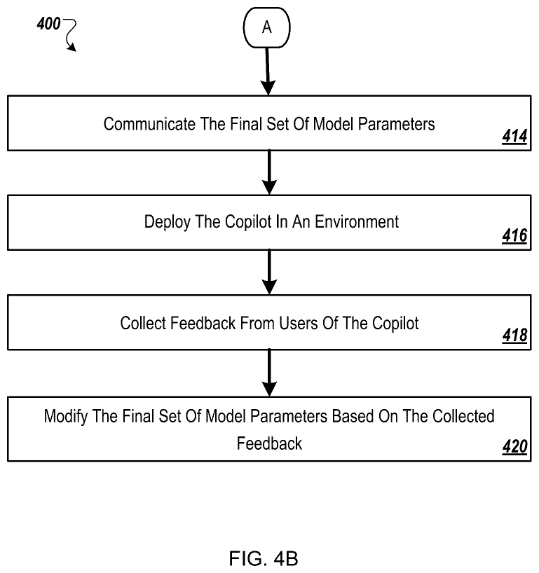

FIGS. 4A and 4B are a flow chart of an example method 400 of augmenting performance and compliance of language model-based copilots, according to at least one embodiment of the present disclosure. Referring to FIG. 4A, the method 400 may begin at block 402 in which application-specific guidance may be received. The application-specific guidance provides one or more instructions that restrict responses output by an application-specific copilot that is based on a large language model (LLM). In some embodiments, the LLM may be connected to application-specific content on which responses from the copilot are based. For instance, the application-specific content may include a technical manual that is directed to an application that the application-specific copilot supports.

At block 404, application-specific guidance may be communicated. The application-specific guidance may be communicated to the LLM such that the guidance is implemented to modify operations implemented by the LLM. For instance, the application-specific guidance may be communicated to the LLM. The LLM may perform one or more operations to incorporate the guidance commute and direct the output by the LLM. An example of the guidance may include “not mentioning a similar application sold by a competitor.” Accordingly, no responses generated by the copilot and the LLM can include mention of the similar application and/or responses generated by the LLM that include the similar application are removed prior to being returned by the copilot.

At block 406, an initial set of model parameters may be set. The initial set of model parameters may be set at the LLM that is implementing the guidance. The initial set of model parameters may be determined in an ad hoc manner in some embodiments and based on expected behavior from related or similar copilot systems. Some examples of the model parameters may include conventional model parameters and/or hyperparameters. For instance, the initial set of model parameters may include values for system prompt, temperature, top_p, similarity threshold, chunk size, embedding model choice, frequency penalty, presence penalty, and other suitable model parameters.

At block 408, model parameters may be sequentially optimized. The model parameters may be sequentially optimized to generate a final set of model parameters. The model parameters may be related to one or more of multiple model output characteristics of the LLM. In some embodiments the output characteristics include alignment of output of the LLM, accuracy of output of the LLM, and consistency of output of the LLM. A subset of parameters related to each of the output characteristics may be optimized sequentially. For instance, the model parameters related to the consistency may be optimized after model parameters related to the alignment and the accuracy are optimized and the model parameters related to the accuracy are optimized after model parameters related to the alignment are optimized.

In some embodiments, block 408 may include sub-operations that are depicted in blocks 410 and 412. At block 410, one or more queries may be generated and submitted to the copilot. The one or more queries may be generated and submitted after the initial set of model parameters are implemented at the LLM. The one or more queries may be configured to test one of the model output characteristics. The one or more queries represent a question that may be input to the copilot by a user after the copilot is deployed. At block 412, copilot responses may be evaluated. The copilot responses may be evaluated based on the guidance. For instance, in circumstances in which the copilot response is contrary to the guidance, one or more of elements of the model parameters, the guidance, or application-specific content may be modified. For example, a parameter of the initial set of model parameters may be adjusted, an order of the application-specific guidance may be adjusted, an input prompt of the application- specific guidance may be adjusted, access and retrieval of the application-specific content may be verified, another adjustment may be made, or some combination thereof. Following modifications, the LLM may be reset, and additional queries may be submitted.

In embodiments in which the parameters are adjusted, the particular parameter of focus may be based on the model output characteristic being optimized. For instance, for the alignment of output of the LLM, the one or more parameters that are adjusted may include selection of different ranges in one or more or a combination of temperature, top_p, presence penalty, and frequency penalty. Additionally, for accuracy of output of the LLM, the adjusting the one or more parameters includes selecting different ranges in one or more or a combination of similarity threshold, chunk size, and embedding model choice. Additionally still, for consistency of output of the LLM, the adjusting the one or more parameters includes selecting of different ranges in one or more or a combination of system prompt, temperature, and top_p.

In some embodiments, evaluation of the copilot responses may include comparing the copilot responses to one or more ground truth responses and scoring the first copilot response using metrics including similarity, relevance, and coherence. In some embodiments, the responses may be manually reviewed. In these and other embodiments, a response may be deemed non-compliant in response to a score assigned to a copilot response being less than a predetermined amount (e.g., a score of 5 out of a possible 10 may be considered non-compliant, etc.).

Referring to FIG. 4B, at block 414, the final set of model parameters may be communicated. The final set of model parameters may be communicated to the LLM such that the final set of model parameters is implemented in the LLM during operations implemented by the copilot. At block 416, the copilot may be deployed. The copilot may be deployed in the environment such that the copilot is configured to receive an actual query and to reply with an actual response based on the LLM implementing the final set of model parameters. At block 418, feedback may be collected. The feedback may be collected from users of the copilot following deployment of the copilot in the environment. At block 420, the final set of model parameters may be modified. The final set of model parameters may be modified based on the collected feedback. After the final set of model parameters is modified, the copilot may be redeployed in the environment.

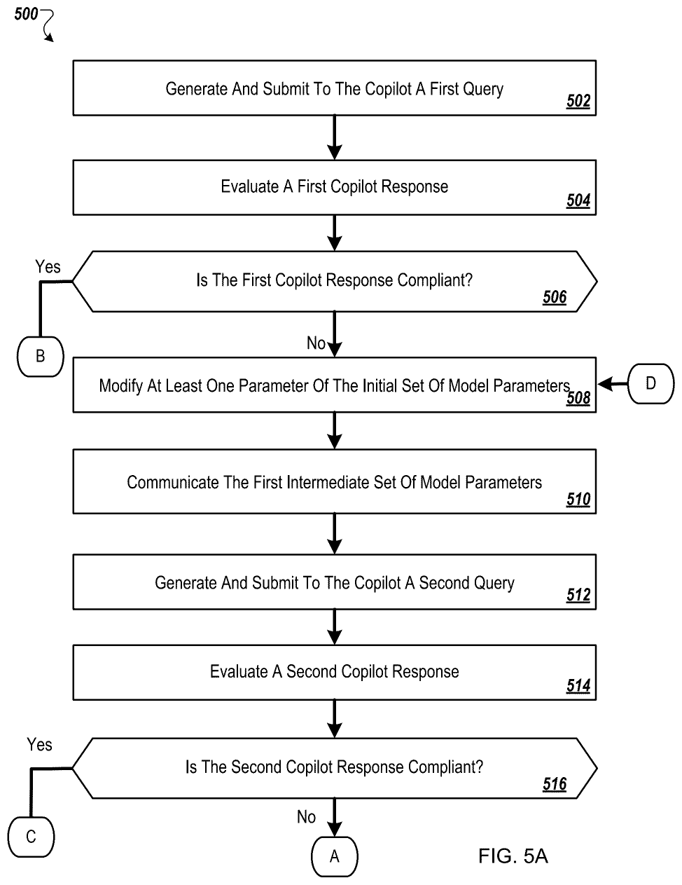

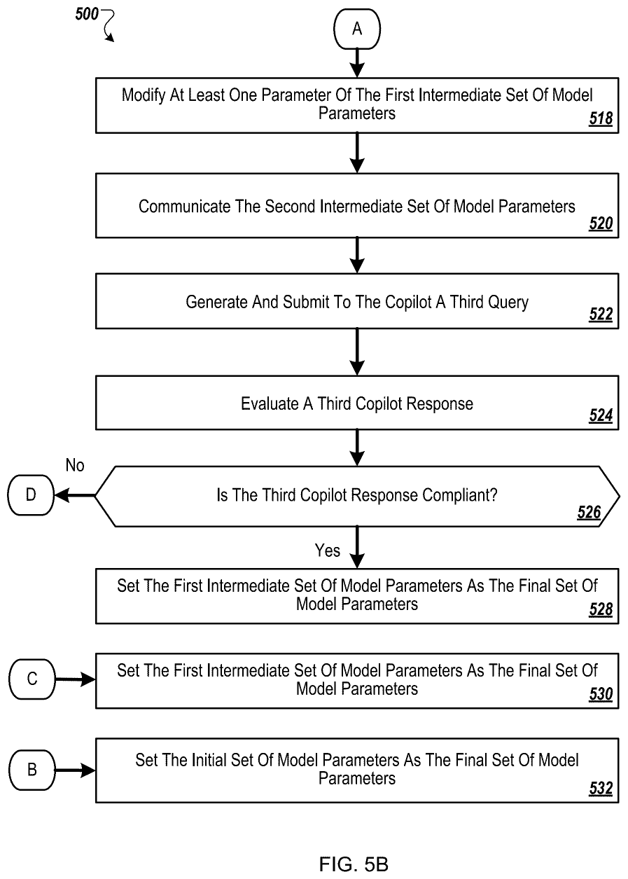

FIGS. 5A and 5B are a flow chart of an example method 500 of optimizing model parameters related to one or more of multiple model output characteristics of an LLM to generate a final set of model parameters with which a copilot is deployed, according to at least one embodiment of the present disclosure. The method 500 may be implemented as part of another method. For instance, the method 500 may be implemented in block 408 of the method 400.

The method 500 may begin at block 502 in which a first query may be generated and submitted. For instance, after an initial set of model parameters application-specific guidance is implemented at the LLM and application-specific content is made available to the LLM, the first query may be generated and submitted. The first query may be configured to test a first model output characteristic of the multiple model output characteristics. The first query represents a question input to the copilot.

At block 504, a first copilot response may be evaluated based on the application- specific guidance. The first copilot response may be received from the copilot to reply to the first query. At block 506, it may be determined whether the first copilot response is compliant. In response to the first copilot response being compliant (“YES” at block 506), the method 500 may proceed to block 532 of FIG. 5B. At block 532, the initial set of model parameters may be set as the final set of model parameters.

In response to the first copilot response being non-compliant (“NO” at block 506), the method 500 may proceed to block 508. Compliance may be based on a score of the copilot responses. For instance, a score range of 1 to 10 may be implemented, with a score of less than 5 being considered non-compliant.

At block 508, at least one parameter of the initial set of model parameters may be modified. The parameter of the initial set of model parameters may be modified to generate a first intermediate set of model parameters. At block 510, the first intermediate set of model parameters may be communicated to the LLM. The first intermediate set of model parameters may be communicated to the LLM to implement the first intermediate set of model parameters. At block 512, a second query may be generated and submitted to the copilot. The second query may be configured to test the first model output characteristic of the LLM after implementation of the first intermediate set of model parameters. At block 514, a second copilot response may be evaluated based on the application-specific guidance. The second copilot response is output by the copilot as a reply or response to the second query.

At block 516, it may be determined whether the second copilot response is compliant. In response to the second copilot response being compliant (“YES” at block 516), the method 500 may proceed to block 530 of FIG. 5B. At block 530, the first intermediate set of model parameters may be set as the final set of model parameters.

In response to the second copilot response being non-compliant (“NO” at block 516), the method 500 may proceed to block 518 of FIG. 5B. At block 518, at least one parameter of the first intermediate set of model parameters may be modified. The parameter of the first intermediate set of model parameters may be modified to generate a second intermediate set of model parameters. At block 520, the second intermediate set of model parameters may be communicated to the LLM. The second intermediate set of model parameters may be communicated to the LLM to implement the second intermediate set of model parameters. At block 522, a third query may be generated and submitted to the copilot. The third query may be configured to test the first model output characteristic of the LLM after implementation of the second intermediate set of model parameters. At block 524, a third copilot response may be evaluated based on the application-specific guidance. The third copilot response is output by the copilot as a reply or response to the third query.

At block 526, it may be determined whether the third copilot response is compliant. In response to the third copilot response being compliant (“YES” at block 526), the method 500 may proceed to block 528 in which the second intermediate set of model parameters may be set as the final set of model parameters. In response to the third copilot response being non-compliant (“NO” at block 528), the method 500 may proceed to block 508 of FIG. 5A. One or more operations of blocks 508, 510, 512, 514, 516, 518, 520, 522, 524, 526, 528, 530, and 532 may be implemented with the additional intermediate sets of model parameters being generated and communicated to the LLM, additional queries being generated, additional copilot responses being evaluated until compliant and a final set of model parameters are determined.

The method 500 may be repeated for multiple output characteristics. In some embodiments, the method 500 may be sequentially performed such that parameters related to a first output characteristic are determined, which is used as the initial set of model parameters for a second output characteristic. Compliance may be tested for one or more previous output characteristics in some embodiments to ensure compliance across each of the output characteristics.

For example, in some embodiments, the model output characteristics include alignment of output of the LLM, accuracy of output of the LLM, and consistency of output of the LLM. The parameters related to the alignment may be determined first (via method 500), followed by parameters related to the accuracy (again via method 500), and then followed by the consistency (again via the method 500).

The parameters that are modified for each of the model output characteristics may differ. For example, in the immediately preceding example, for alignment of output of the LLM, the one or more parameters that are modified or adjusted may include selection of different ranges in one or more or a combination of temperature, top_p, presence penalty, and frequency penalty. For accuracy of output of the LLM, the one or more parameters adjusted or modified may include selecting different ranges in one or more or a combination of similarity threshold, chunk size, and embedding model choice. For consistency of output of the LLM, the one or more parameters adjusted or modified may include selecting different ranges in one or more or a combination of system prompt, temperature, and top_p.

In these and other embodiments, the queries may be dynamic or static. For instance, a first model output characteristic of the LLM may include alignment of output of the LLM. The first query, the second query, and the third query may be static. Additionally, the first model output characteristic of the LLM may include accuracy of output of the LLM or consistency of output of the LLM and the first query, the second query, and the third query may be dynamic. Additionally, in some embodiments, the first query, the second query, and the third query are based on user feedback.

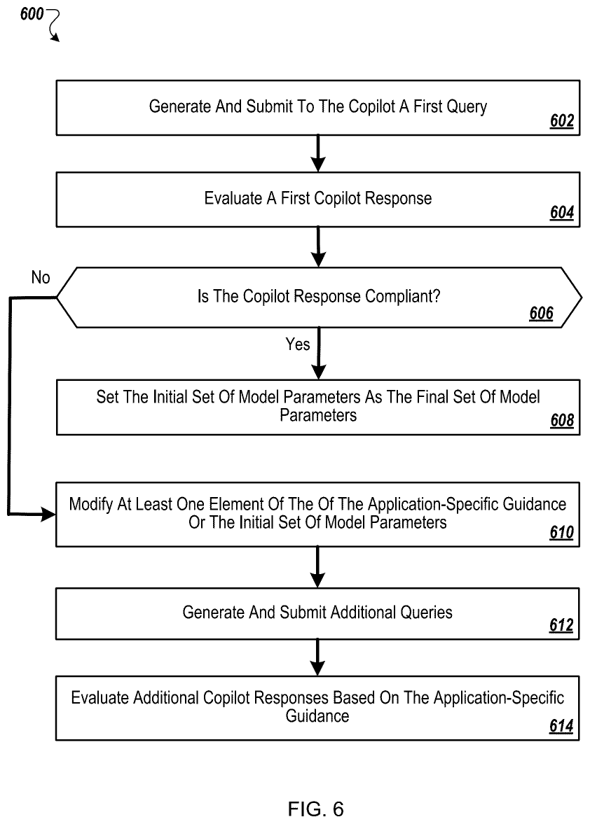

FIG. 6 is a flow chart of an example method 600 of optimizing model parameters related to one or more of multiple model output characteristics of an LLM to generate a final set of model parameters with which a copilot is deployed, according to at least one embodiment of the present disclosure. The method 600 may be implemented as part of another method. For instance, the method 600 may be implemented in block 608 of the method 400. The method 600 may be implemented after the initial set of model parameters are implemented at the LLM (e.g., block 406 of the method 400).

The method 600 may begin at block 602, in which a first query may be generated and submitted to the copilot. The first query is configured to test a first model output characteristic of the multiple model output characteristics and represents a question input to the copilot. At block 604, a first copilot response may be evaluated based on application-specific guidance. The application-specific guidance may be communicated to the LLM to restrict output therefrom. The first copilot response may be received as a reply to the first query.

At block 606, it may be determined whether the first copilot response is compliant based on the evaluation in block 604. In response to the first copilot response being compliant with the application-specific guidance (“YES” at block 606), the method 600 may proceed to block 608 in which the initial set of model parameters may be set as the final set of model parameters.

In response to the first copilot response being non-compliant with the application-specific guidance (“NO” at block 606), the method 600 may proceed to block 610. At block 610, at least one element of the application-specific guidance or the initial set of model parameter may be modified. For instance, the application-specific guidance may be revised or reordered and resubmitted to the LLM. Additionally or alternatively, one or more of the sets of model parameters may be adjusted or modified. At block 612, additional queries may be generated and submitted to the copilot. The additional queries may be configured to test the first model output characteristic of the LLM after implementation of modified elements at the copilot. At block 614, additional copilot responses may be evaluated based on the application- specific guidance. From block 614, the method 600 may proceed to block 606 and may continue through one or more of blocks 608, 610, 612, 614, and 606 until the model output response is compliant.

Although illustrated as discrete blocks, one or more blocks in FIGS. 4A-6 may be divided into additional blocks, combined into fewer blocks, or eliminated, depending on the desired implementation. One or more of the methods described in the present disclosure may be performed in a suitable operating environment such as the operating environment 100. The methods 400, 500, or 600 may be performed by the management system 104 or another computing device (e.g., 300 of FIG. 3). In some embodiments, the management system 104 or another computing system may include or may be communicatively coupled to a non- transitory computer-readable medium (e.g., the memory 312 of FIG. 3) having stored thereon programming code or instructions that are executable by one or more processors (such as the processor 310 of FIG. 3) to cause a computing system or the management system 104 to perform or control performance of the methods. Additionally or alternatively, the management system 104 or another computing device may include the processor 310 described elsewhere in this disclosure that is configured to execute computer instructions to cause the management system 104 or another computing system to perform or control performance of the methods.

Further, modifications, additions, or omissions may be made to the methods without departing from the scope of the present disclosure. For example, the operations of methods may be implemented in differing orders. Furthermore, the outlined operations and actions are only provided as examples, and some of the operations and actions may be optional, combined into fewer operations and actions, or expanded into additional operations and actions without detracting from the disclosed embodiments.

The embodiments described herein may include the use of a special purpose or general-purpose computer including various computer hardware or software modules, as discussed in greater detail below.

Embodiments described herein may be implemented using computer-readable media for carrying or having computer-executable instructions or data structures stored thereon. Such computer-readable media may be any available media that may be accessed by a general purpose or special purpose computer. By way of example, and not limitation, such computer-readable media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general purpose or special purpose computer. Combinations of the above may also be included within the scope of computer-readable media.

Computer-executable instructions may include, for example, instructions and data, which cause a general-purpose computer, special purpose computer, or special purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the terms “module” or “component” may refer to specific hardware implementations configured to perform the operations of the module or component and/or software objects or software routines that may be stored on and/or executed by general purpose hardware (e.g., computer-readable media, processing devices, etc.) of the computing system. In some embodiments, the different components, modules, engines, and services described herein may be implemented as objects or processes that execute on the computing system (e.g., as separate threads). While some of the systems and methods described herein are generally described as being implemented in software (stored on and/or executed by general purpose hardware), specific hardware implementations or a combination of software and specific hardware implementations are also possible and contemplated. In this description, a “computing entity” may be any computing system as previously defined herein, or any module or combination of modulates running on a computing system.

The various features illustrated in the drawings may not be drawn to scale. The illustrations presented in the present disclosure are not meant to be actual views of any particular apparatus (e.g., device, system, etc.) or method, but are representations employed to describe embodiments of the disclosure. Accordingly, the dimensions of the features may be expanded or reduced for clarity. In addition, some of the drawings may be simplified for clarity. Thus, the drawings may not depict all of the components of a given apparatus (e.g., device) or all operations of a particular method.

Terms used in the present disclosure and the claims (e.g., bodies of the appended claims) are intended as “open” terms (e.g., the term “including” should be interpreted as “including, but not limited to,” the term “having” should be interpreted as “having at least,” the term “includes” should be interpreted as “includes, but is not limited to,” among others). Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in instances in which a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. Further, any disjunctive word or phrase presenting two or more alternative terms should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

The terms “first,” “second,” “third,” etc., are not necessarily used to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art and are to be construed as being without limitation to such specifically recited examples and conditions. Although embodiments of the present inventions have been described in detail, it should be understood that the various changes, substitutions, and alterations could be made hereto without departing from the scope of the invention.

What is claimed is:

1. A method of augmenting performance and compliance of language model-based copilots, the method comprising:
receiving application-specific guidance that provides one or more instructions that restrict responses output by an application-specific copilot that is based on a large language model (LLM);
communicating to the LLM the application-specific guidance;
setting an initial set of model parameters for the LLM;
sequentially optimizing model parameters related to one or more of multiple model output characteristics of the LLM to generate a final set of model parameters, wherein the optimizing the model parameters includes:
after the initial set of model parameters are implemented at the LLM, generating and submitting to the copilot a first query configured to test a first model output characteristic of the multiple model output characteristics, wherein the first query represents a question input to the copilot, and the multiple model output characteristics include alignment of output of the LLM, accuracy of output of the LLM, and consistency of output of the LLM; and
evaluating a first copilot response based on the application-specific guidance, wherein evaluation of the first copilot response includes comparing the first copilot response to one or more ground truth responses and scoring the first copilot response using metrics including similarity, relevance, and coherence;
communicating the final set of model parameters to the LLM such that the final set of model parameters is implemented in the LLM during operations implemented by the copilot; and
deploying the copilot in an environment such that the copilot is configured to receive an actual query and to reply with an actual response based on the LLM implementing the final set of model parameters.

2. The method of claim 1, wherein the optimizing the model parameters further includes in response to the first copilot response being non-compliant with at least one aspect of the application-specific guidance:
modifying at least one parameter of the initial set of model parameters to generate a first intermediate set of model parameters;
communicating the first intermediate set of model parameters to the LLM to implement the first intermediate set of model parameters;
generating and submitting to the copilot a second query configured to test the first model output characteristic of the LLM after implementation of the first intermediate set of model parameters; and
based on the application-specific guidance, evaluating a second copilot response that is responsive to the second query;
in response to the second copilot response being non-compliant with at least one aspect of the application-specific guidance:
modifying at least one parameter of the first intermediate set of model parameters to generate a second intermediate set of model parameters;
communicating the second intermediate set of model parameters to the LLM to implement the second intermediate set of model parameters;
generating and submitting to the copilot a third query configured to test the first model output characteristic of the LLM after implementation of the second intermediate set of model parameters; and
evaluating a third copilot response based on the application-specific guidance;
in response to the third copilot response being compliant with the application- specific guidance, setting the second intermediate set of model parameters as the final set of model parameters; and
in response to the second copilot response being compliant with the application-specific guidance, setting the first intermediate set of model parameters as the final set of model parameters; and
in response to the first copilot response being compliant with the application-specific guidance, setting the initial set of model parameters as the final set of model parameters.

3. The method of claim 2, wherein:
the first model output characteristic of the LLM includes alignment of output of the LLM; and
the first query, the second query, and the third query are static.

4. The method of claim 2, wherein:
the first model output characteristic of the LLM includes accuracy of output of the LLM or consistency of output of the LLM; and
the first query, the second query, and the third query are dynamic.

5. The method of claim 4, wherein the first query, the second query, and the third query are based on user feedback.

6. The method of claim 1, wherein the optimizing the model parameters further includes in response to the first copilot response being non-compliant with at least one aspect of the application-specific guidance:
adjusting a first parameter of the initial set of model parameters;
adjusting an order of the application-specific guidance;
adjusting an input prompt of the application-specific guidance; or verifying application-specific content is retrieved by the LLM.

7. The method of claim 1, wherein:
model parameters related to the consistency are optimized after model parameters related to the alignment and the accuracy are optimized; and
model parameters related to the accuracy are optimized after model parameters related to the alignment are optimized.

8. The method of claim 1, wherein:
for alignment of output of the LLM, the one or more parameters that are adjusted include selection of different ranges in one or more or a combination of temperature, top_p, presence penalty, and frequency penalty;
for accuracy of output of the LLM, the adjusting the one or more parameters includes selecting different ranges in one or more or a combination of similarity threshold, chunk size, and embedding model choice; and
for consistency of output of the LLM, the adjusting the one or more parameters includes selection of different ranges in one or more or a combination of system prompt, temperature, and top_p.

9. The method of claim 1, wherein evaluation of the first copilot response includes a manual review of the first copilot response.

10. The method of claim 1, wherein the optimizing the model parameters includes:
in response to the first copilot response being compliant with the application-specific guidance, setting the initial set of model parameters as the final set of model parameters; and
in response to the first copilot response being non-compliant with at least one aspect of the application-specific guidance:
modifying at least one element of the application-specific guidance or the initial set of model parameters;
generating and submitting, to the copilot, additional queries configured to test the first model output characteristic of the LLM after implementation of modified elements at the copilot; and
evaluating additional copilot responses based on the application-specific guidance.

11. A non-transitory computer-readable medium having encoded therein programming code executable by one or more processors to perform or control performance of operations of augmenting performance and compliance of language model-based copilots, the operations comprising:
receiving application-specific guidance that provides one or more instructions that restrict responses output by an application-specific copilot that is based on a large language model (LLM);
communicating to the LLM the application-specific guidance;
setting an initial set of model parameters for the LLM;
sequentially optimizing model parameters related to one or more of multiple model output characteristics of the LLM to generate a final set of model parameters, wherein the optimizing the model parameters includes:
after the initial set of model parameters are implemented at the LLM, generating and submitting to the copilot a first query configured to test a first model output characteristic of the multiple model output characteristics, wherein the first query represents a question input to the copilot, and the multiple model output characteristics include alignment of output of the LLM, accuracy of output of the LLM, and consistency of output of the LLM; and
evaluating a first copilot response based on the application-specific guidance, wherein evaluation of the first copilot response includes comparing the first copilot response to one or more ground truth responses and scoring the first copilot response using metrics including similarity, relevance, and coherence;
communicating the final set of model parameters to the LLM such that the final set of model parameters is implemented in the LLM during operations implemented by the copilot; and
deploying the copilot in an environment such that the copilot is configured to receive an actual query and to reply with an actual response based on the LLM implementing the final set of model parameters.

12. The non-transitory computer-readable medium of claim 11, wherein the optimizing the model parameters further includes in response to the first copilot response being non-compliant with at least one aspect of the application-specific guidance:
modifying at least one parameter of the initial set of model parameters to generate a first intermediate set of model parameters;
communicating the first intermediate set of model parameters to the LLM to implement the first intermediate set of model parameters;
generating and submitting to the copilot a second query configured to test the first model output characteristic of the LLM after implementation of the first intermediate set of model parameters; and
based on the application-specific guidance, evaluating a second copilot response that is responsive to the second query;
in response to the second copilot response being non-compliant with at least one aspect of the application-specific guidance:
modifying at least one parameter of the first intermediate set of model parameters to generate a second intermediate set of model parameters;
communicating the second intermediate set of model parameters to the LLM to implement the second intermediate set of model parameters;
generating and submitting to the copilot a third query configured to test the first model output characteristic of the LLM after implementation of the second intermediate set of model parameters; and
evaluating a third copilot response based on the application-specific guidance;
in response to the third copilot response being compliant with the application- specific guidance, setting the second intermediate set of model parameters as the final set of model parameters; and
in response to the second copilot response being compliant with the application-specific guidance, setting the first intermediate set of model parameters as the final set of model parameters; and
in response to the first copilot response being compliant with the application-specific guidance, setting the initial set of model parameters as the final set of model parameters.

13. The non-transitory computer-readable medium of claim 12, wherein:
the first model output characteristic of the LLM includes alignment of output of the LLM; and
the first query, the second query, and the third query are static.

14. The non-transitory computer-readable medium of claim 12, wherein:
the first model output characteristic of the LLM includes accuracy of output of the LLM or consistency of output of the LLM; and
the first query, the second query, and the third query are dynamic.

15. The non-transitory computer-readable medium of claim 14, wherein the first query, the second query, and the third query are based on user feedback.

16. The non-transitory computer-readable medium of claim 11, wherein the optimizing the model parameters further includes in response to the first copilot response being non-compliant with at least one aspect of the application-specific guidance:
adjusting a first parameter of the initial set of model parameters;
adjusting an order of the application-specific guidance;
adjusting an input prompt of the application-specific guidance; or
verifying application-specific content is retrieved by the LLM.

17. The non-transitory computer-readable medium of claim 11, wherein:
model parameters related to the consistency are optimized after model parameters related to the alignment and the accuracy are optimized; and
model parameters related to the accuracy are optimized after model parameters related to the alignment are optimized.

18. The non-transitory computer-readable medium of claim 11, wherein:
for alignment of output of the LLM, the one or more parameters that are adjusted include selection of different ranges in one or more or a combination of temperature, top_p, presence penalty, and frequency penalty;
for accuracy of output of the LLM, the adjusting the one or more parameters includes selecting different ranges in one or more or a combination of similarity threshold, chunk size, and embedding model choice; and
for consistency of output of the LLM, the adjusting the one or more parameters includes selection of different ranges in one or more or a combination of system prompt, temperature, and top_p.

19. The non-transitory computer-readable medium of claim 11, wherein evaluation of the first copilot response includes a manual review of the first copilot response.

20. The non-transitory computer-readable medium of claim 11, wherein the optimizing the model parameters includes:
in response to the first copilot response being compliant with the application-specific guidance, setting the initial set of model parameters as the final set of model parameters; and
in response to the first copilot response being non-compliant with at least one aspect of the application-specific guidance:
modifying at least one element of the application-specific guidance or the initial set of model parameters;
generating and submitting, to the copilot, additional queries configured to test the first model output characteristic of the LLM after implementation of modified elements at the copilot; and
evaluating additional copilot responses based on the application-specific guidance.
